(19) United States
(12) Patent Application Publication
(10) Pub. No.: US 2006/0070817 A1
(43) Pub. Date: Apr. 6, 2006

(54) Mast lift machine

(75) Inventors: Geoffrey George Campbell, Kensington (AU); Ignacy Puszkiewicz, Smithsburg, MD (US)

Correspondence Address: NIXON & VANDERHYE, PC, 901 NORTH GLEBE ROAD, 11TH FLOOR, ARLINGTON, VA, 22203, US

(73) Assignee: JLG Industries, Inc., McConnellsburg, PA (US)

(21) Appl. No.: 11/214,027

(22) Filed: Aug. 30, 2005

Related U.S. Application Data
(63) Continuation of application No. PCT/US05/14356, filed on Apr. 27, 2005.
(60) Provisional application No. 60/565,524, filed on Apr. 27, 2004.

(51) Int. Cl. B66F 9/08

(52) U.S. Cl. 187/238

(57) ABSTRACT

A portable mast lift includes a base unit having a mast and a platform lifting system. A work platform is raised and lowered on the mast of the lifting system. The mast lift is transportable and operable by a single user. In one arrangement, a machine weight of the mast lift is less than 200 lbs. Additionally, the mast lift is preferably supported in use at two support points. Multiple embodiments of the mast lift provide for varying maximum reach and load limits.

### CROSS-REFERENCES TO RELATED APPLICATIONS

This application is a continuation of PCT International Patent Application No. PCT/US2005/014356, filed Apr. 27, 2005, which claims the benefit of U.S. Provisional Patent Application Ser. No. 60/565,524, filed Apr. 27, 2004, the entire contents of which are hereby incorporated by reference in this application.

### STATEMENT REGARDING FEDERALLY SPONSORED RESEARCH OR DEVELOPMENT

(NOT APPLICABLE)

### BACKGROUND OF THE INVENTION

The present invention relates to a personnel lift and, more particularly, to a portable lift machine including a work platform raised and lowered on a mast by a lifting system. The lifting machine is transportable and operable by a single user.

The ladder concept is several thousand years old. Existing ladders, however, can be cumbersome and difficult to maneuver. Additionally, conventional ladders can be unstable particularly on uneven ground, and a work area is limited to the user's reach.

Ladder companies are reluctant to develop powered mechanical products. It would be desirable, however, to develop a personnel lift that achieves many of the advantages of a ladder, e.g., can be set up and used by a single operator, lightweight, etc., while providing for greater stability and a larger working area in a portable powered machine.

Mast climbing platforms are known and typically include a mast that can be free-standing or supported by a wall or other support structure. Existing mast climbers, however, are not portable or operable by a single user due to their size. Vertical mast products include a moving platform and generally are only free-standing assemblies. These machines are also typically too large for portability, have minimum SWL loads of 1000 lb, and are very far from the many advantages provided by a ladder in terms of portability, low cost and ease of use.

### BRIEF SUMMARY OF THE INVENTION

The mast lift proposed according to the present invention is readily transportable and operable by a single user, typically having a machine weight less than 200 lbs. The work platform includes side protection that moves with the user and materials. Moreover, the mast on which the work platform travels is supported in use at two support positions such that the machine is not free-standing or self-supporting, resulting in a more stable structure.

In an exemplary embodiment of the invention, a mast lift includes a mast, a work platform movably secured to the mast, and a lift system coupled between the work platform and the mast. The lift system effects raising and lowering of the work platform on the mast. Preferably, a machine weight of the mast lift is less than 200 pounds, or less than 150 pounds, or less than 120 pounds. The work platform may be provided with a foldable safety rail about its perimeter. The lift system is preferably coupleable with a power source such as a battery pack, a hand-held drill, or an electric power unit connected to commonly used AC power outlets. A stand supports the mast, where the mast lift requires two support points, and the stand defines one of the two support points. Preferably, the stand includes one or more extendible and retractable legs each having a dual lock mechanism that locks the legs in an engaged position. The dual lock mechanism is engaged based on (1) a position of the legs and (2) a load on the legs.

The mast lift may additionally include a mast arm coupled with the mast, where the mast arm defines the other of the two support points. In this context, the mast arm may be pivotable between a transport position and a use position.

In one arrangement, the mast includes telescoping sections positionable between a stowed position and an extended position. In this context, the mast arm coupled with the mast is pivotable between a transport position when the telescoping sections are in the stowed position and a use position when the telescoping sections are in the extended position. Preferably, the mast arm is biased toward the use position, where a pivot bracket engages the mast arm when the telescoping sections are in the stowed position. In this arrangement, the mast arm may be locked in the use position via an over-center arrangement.

In another exemplary embodiment of the invention, a mast lift is configurable with a plurality of independent components, including a base unit including a mast, a stand and a platform lifting system; a work platform attachable to the base unit; and an optional power pack engageable with the platform lifting system.

In yet another exemplary embodiment of the invention, a mast lift includes a mast; a work platform movably secured to the mast, where the work platform has a safety rail about its perimeter; a lift system coupled between the work platform and the mast, the lift system effecting raising and lowering of the work platform on the mast; and a stand supporting the mast, where the mast lift requires two support points, and where the stand defines only one of the two support points.

In still another exemplary embodiment of the invention, a portable platform lifting machine includes a base unit having a mast and a platform lifting system, and a work platform that is raised and lowered on the mast by the lifting system, where the lifting machine is transportable and operable by a single user, and wherein the lifting machine is supported in use at two support points.

### BRIEF DESCRIPTION OF THE DRAWINGS

These and other aspects and advantages of the present invention will be described in detail with reference to the accompanying drawings, in which:

FIG. 1 is a front perspective view of a first embodiment personnel lift according to the present invention in a lowered position;

FIG. 2 is a rear perspective view of the lift shown in FIG. 1;

FIGS. 3 and 4 show the lift of FIG. 1 in a raised position;

FIG. 5 is a close-up rear perspective view of the stand and platform of the lift shown in FIG. 1;

FIG. 6 is a close-up view of the dual lock mechanism;

FIGS. 7-9 are views of the dual lock mechanism and an extendible support leg;

FIG. 10 illustrates a lacking bracket that prevents platform raising when the lift is not properly supported;

FIG. 11 is a close-up view of the pulley system for raising and lowering the telescoping mast;

FIG. 12 is a close-up view of the mast arm and its pivot mechanism;

FIG. 13 is schematic illustration of the lifting system and alternative power sources;

FIGS. 14 and 15 are close-up views of the swing-over roller;

FIG. 16 is a perspective view of the lift platform;

FIG. 17 is a front perspective view of a second embodiment personnel lift according to the invention;

FIG. 18 is a rear perspective view of the lift shown in FIG. 17;

FIG. 19 illustrates a third embodiment of the invention;

FIG. 20 is a front perspective view of a fourth embodiment personnel lift according to the present invention in a lowered position;

FIG. 21 is a rear perspective view of the lift shown in FIG. 20;

FIGS. 22 and 23 show the lift of FIG. 20 in a raised position; and

FIG. 24 is a rear perspective view with a portion of the mast cut away.

### DETAILED DESCRIPTION OF THE INVENTION

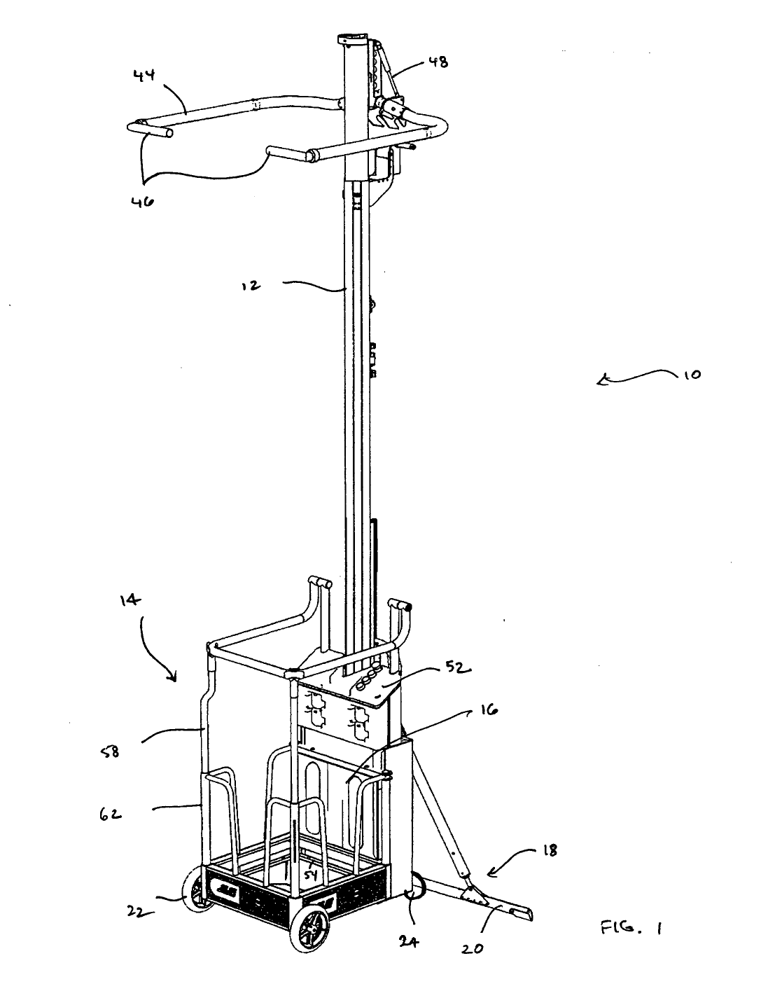

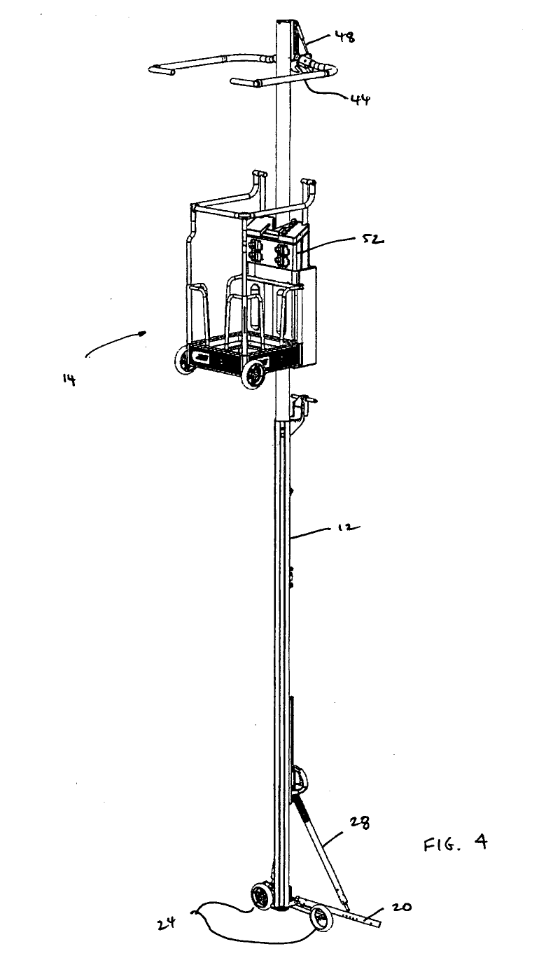

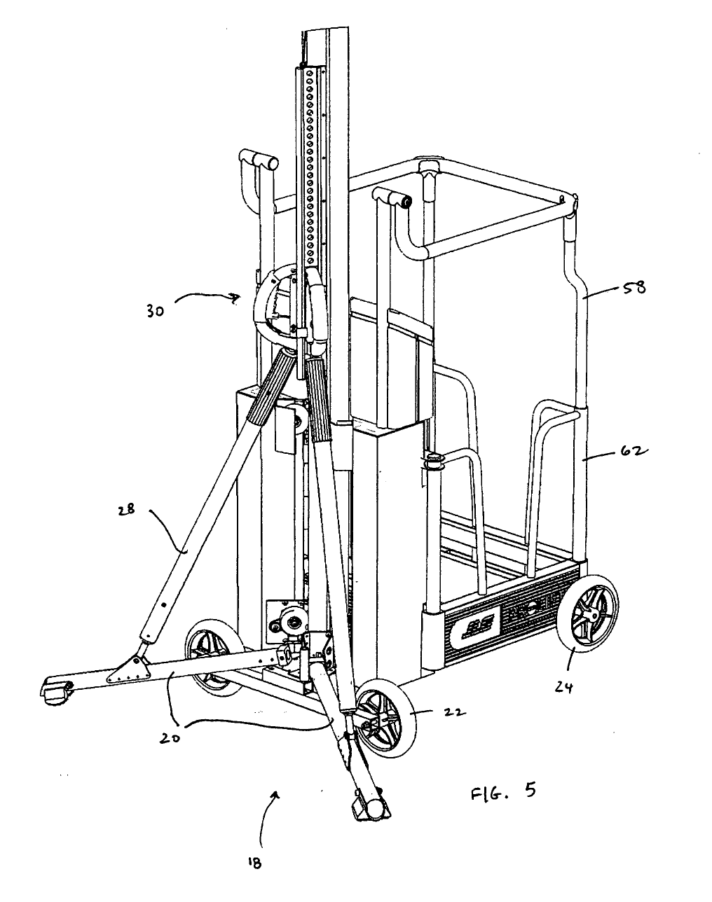

With reference to FIGS. 1-5, a first embodiment of a mast lift according to the present invention is shown. The lift 10 includes a telescoping mast 12, a detachable work platform 14 movably secured to the mast 12, and a lift system 16 acting between the work platform 14 and the mast 12 to raise and lower the work platform 14 on the mast 12.

The mast 12 is supportable in two configurations by a stand 18. The stand 18 includes a pair of retractable supporting legs 20, a pair of transport wheels 22, and a pair of traversing wheels 24. In the transport position, the legs 20 are retracted, and positioning of the mast lift 10 can be performed by a single user by shifting the mast lift such that its weight rests on either set of wheels 22, 24. For example, if a user desires to shift a position of the mast lift 10 in a side-to-side direction (e.g., along a wall), with the legs 20 retracted, the mast lift 10 is tilted backward so that its weight is supported by the traversing wheels 24, and the mast lift 10 can be rolled in a lateral direction. In a similar context, if the user desires to move the mast lift 10 closer to or farther away from the wall, the mast lift 10 is leaned so that its weight is supported by the transport wheels 22.

When the mast lift 10 is placed in a desired position, the legs 20 are extended to engage the ground. In a preferred arrangement, the legs 20 are secured to the stand 18 via a pivot 26. An extender bracket 28 is pivotally attached between a sliding dual lock mechanism 30 (described below) slidably engaged with the mast 12 and an intermediate point between ends of the legs 20. The ground engaging end of the legs 20 may include a non-slip pad 32 or the like for better adherence to the ground. As the dual lock mechanism 30 is slid downward along the mast, the extender brackets 28 pivot the legs 20 toward engagement with the ground.

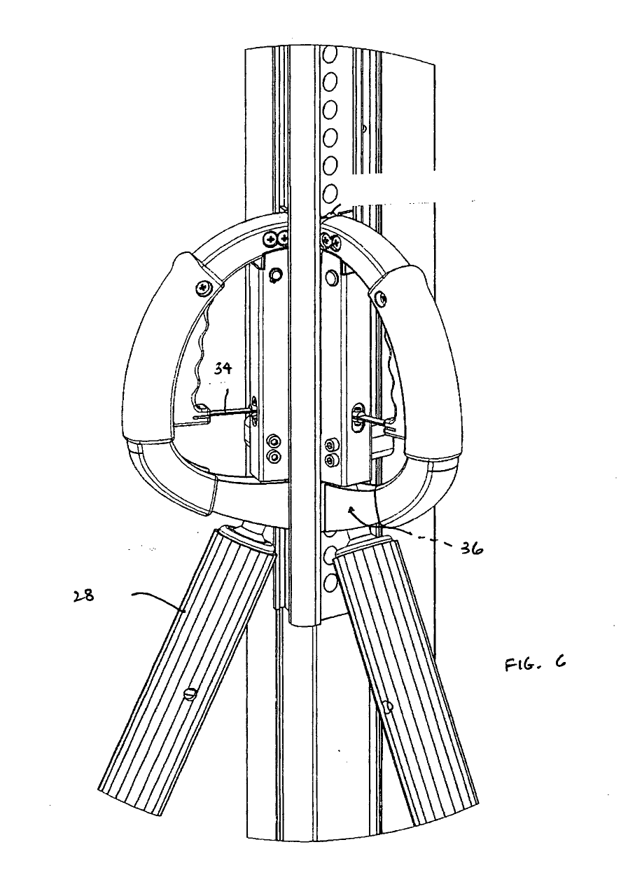

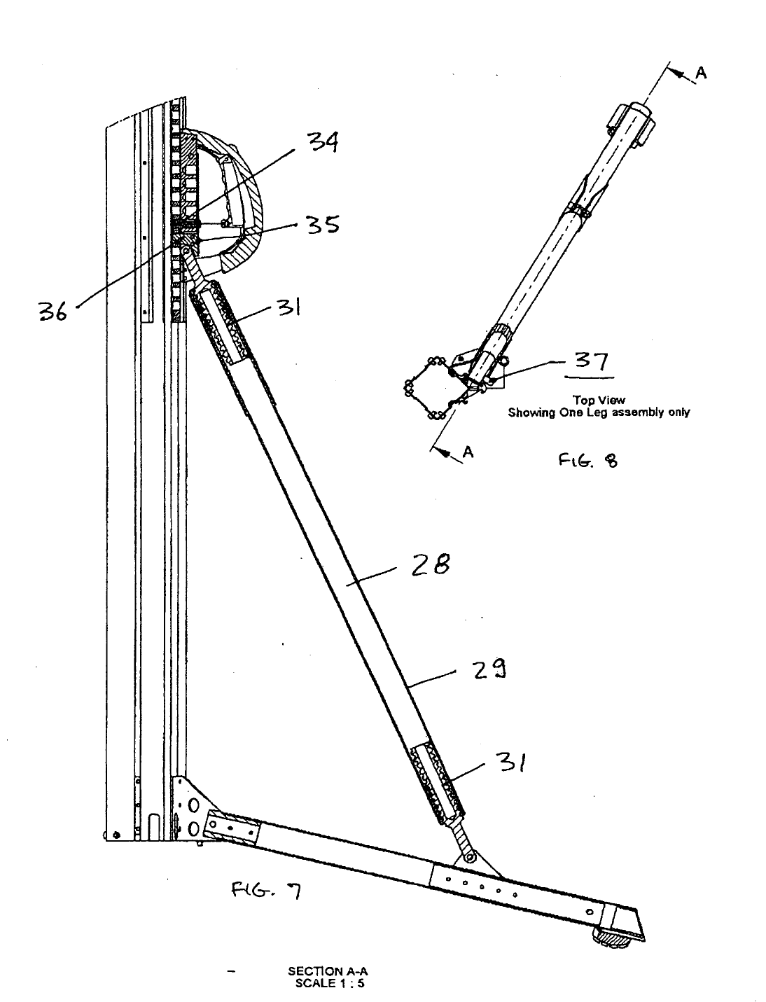

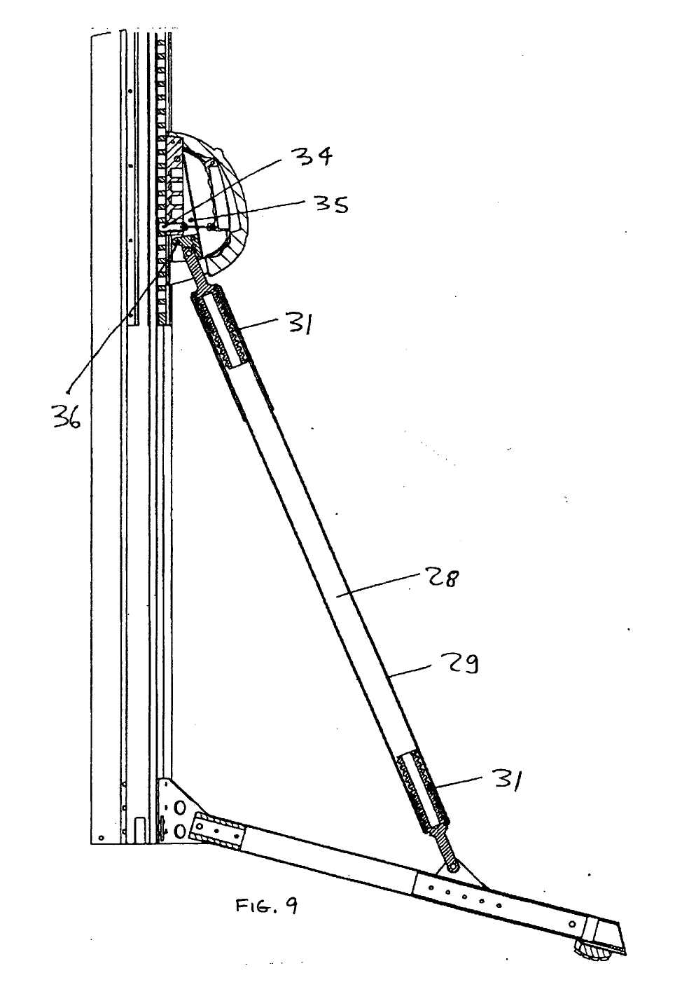

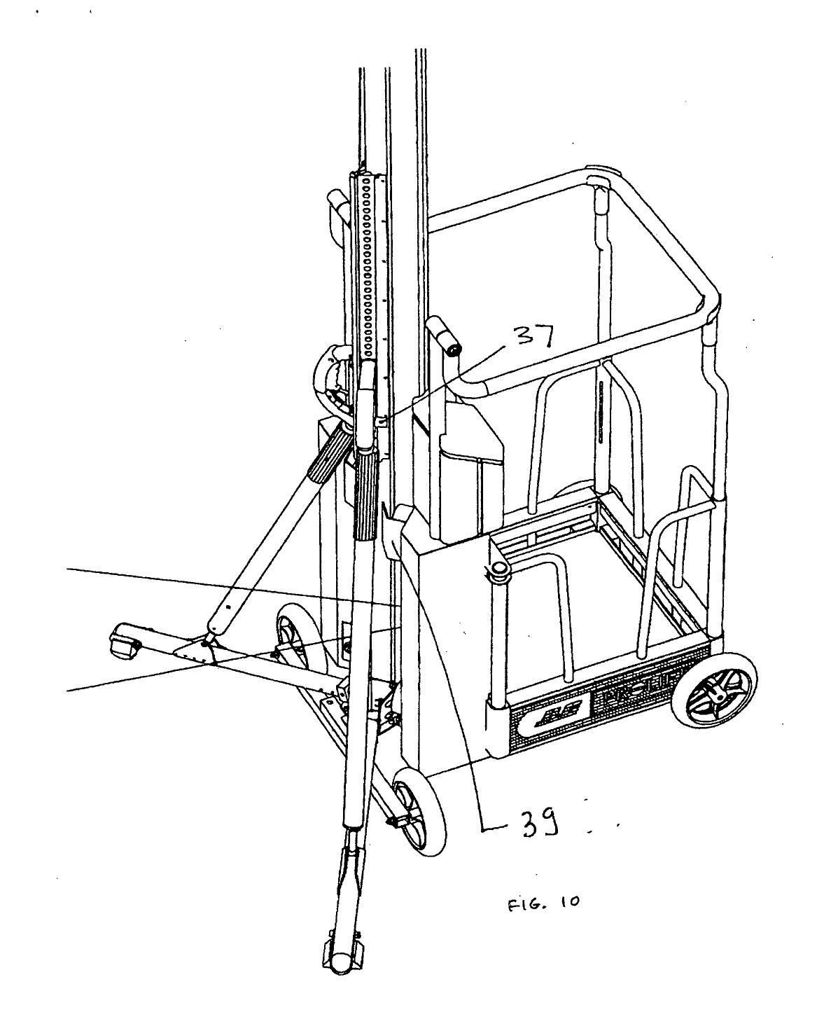

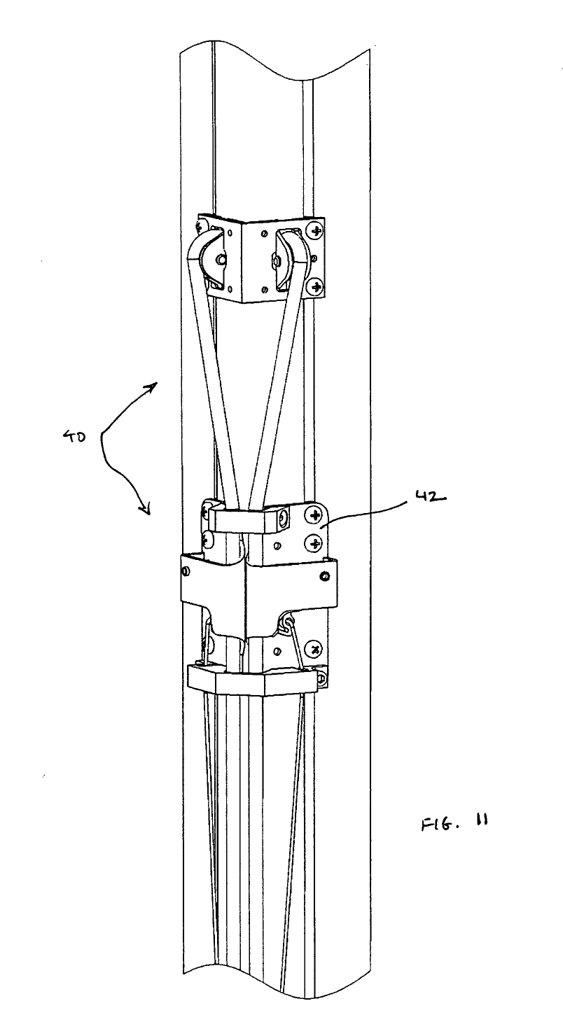

To ensure a stable support structure for the work platform 14, the mast lift 10 is designed such that it preferably requires two support points. A first support point is defined by the engagement of the legs 20 with the ground. For stability, it is important that the legs 20 support the weight of the mast lift 10. The dual lock mechanism 30 serves to lock the legs in the engaged position and provides a mechanical interlock preventing platform movement if the legs 20 are not properly deployed. With reference to FIGS. 6-10, the dual lock mechanism 30 is engaged based on (1) a position of the legs 20, and (2) a load on the legs 20. In an exemplary embodiment, the dual lock mechanism 30 includes two locking pins, a position locking pin 34 that locks the legs 20 in the engaged position, and a load locking pin 36 that is engaged when a predetermined load is placed on the legs 20. To engage the load locking pin 36, after extending the legs 20 and engaging the position locking pin 34, the extender brackets 28 are lengthwise extended by rotating an outer tube 29 about a threaded core 31. As the extender brackets 28 are lengthened, the legs 20 are driven into the ground, and the weight of the mast lift 10 is supported solely by the legs 20. When the load on the extender brackets 28 exceeds a predetermined amount, the load locking pin 36 is engaged. The extender brackets 28 can be lengthened independently to level the mast lift 10. Engagement of the locking pin 36 permits a locking bracket 37 to rotate toward the mast 12 and thereby allow the platform 14 to pass by on the way up the mast 12. Without engagement, the platform 14 is prevented from being raised by virtue of a tab member 39 engaging the locking bracket 37.

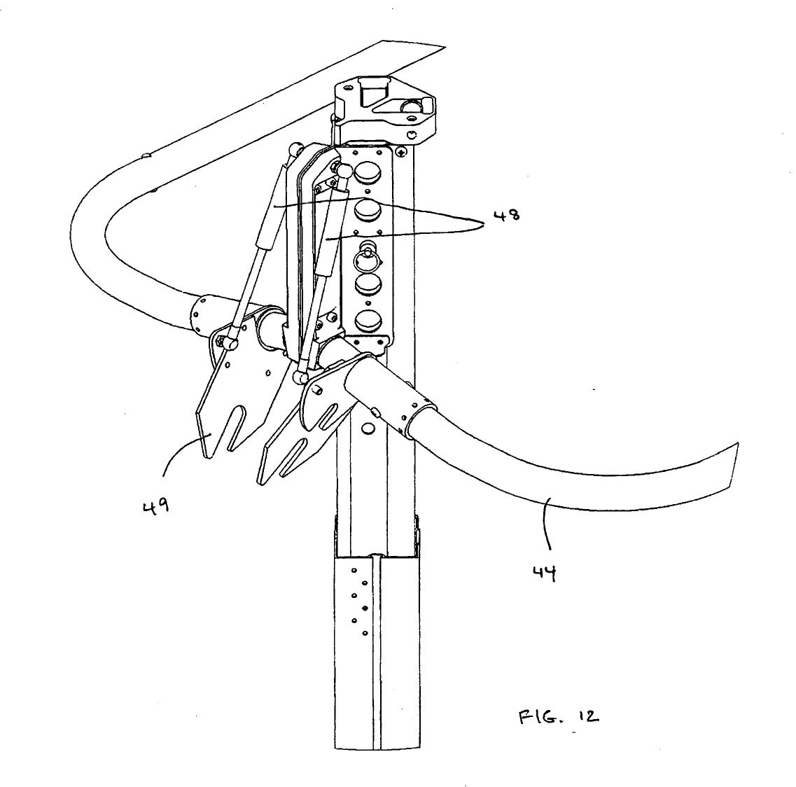

In this embodiment, the mast 12 is comprised of two telescoping sections 38. The mast 12 can be raised and lowered using any suitable configuration. In the embodiment illustrated in FIG. 1, a pulley system 40 is used and includes a suitable pulley lock 42. See FIG. 11.

A mast arm 44 preferably includes two support ends 46 that engage a supporting structure and serves as the other of the two support points required in the exemplary arrangement for stability. The support ends 46 may themselves be adjustable, i.e., extendible and retractable, rotatable, etc., to provide flexibility in positioning the lift around windows or other obstructions. The mast arm 44 is pivotable between a transport position when the mast 12 is lowered and a use position when the mast 12 is raised. In a preferred arrangement, the mast arm 44 is biased toward the use position by a pair of gas struts 48. See FIG. 12. The gas struts 48 shift the mast arm 44 to its use position when the mast is raised to a degree slightly beyond horizontal such that when the support ends 46 engage the support structure, the mast arm 44 is placed in an over-center position to thereby prevent the mast arm 44 from being pivoted against the force of the gas struts 48 when a load is on the work platform 14.

As the mast 12 is lowered, a closing bracket 49 of the mast arm 44 is engaged by a retracting bracket 50 that pivots the mast arm 44 against the force of the gas struts 48 and holds the mast arm 44 in its transport position. In this position, the mast arm 44 is generally parallel to the mast 12.

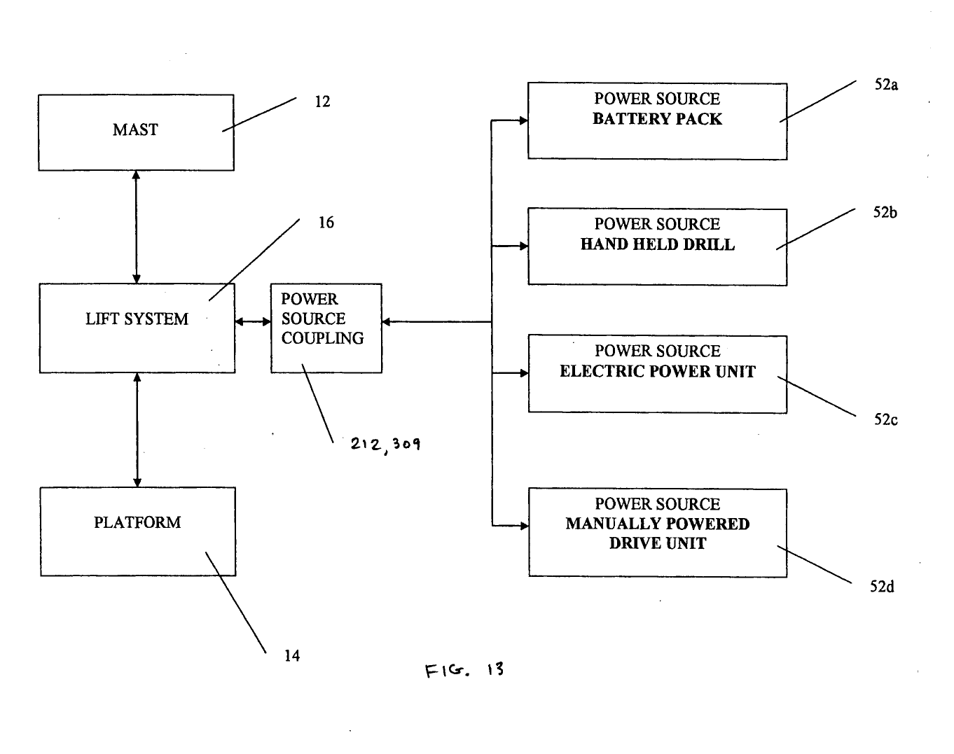

With the two support points secured by the legs 20 and the mast arm 44, the mast lift is set for operation. The lift system 16 is coupled between the work platform 14 and the mast 12. Although any suitable lift system may be used with the mast lift of the present invention, in the preferred arrangement, a worm screw drives a gear train that takes in and reels out a lifting cable or strap. A system schematic is shown in FIG. 13. A power source 52 (52a-52d) drives one or more worm screws via operator control through a power source coupling 212 to raise and lower the platform 14 on the mast. The power source 52 may be an independent rechargeable unit 52a that is attachable to ends of the worm screws. Other power sources for driving the worm screws may also be suitable, such as a power drill 52b or power pack 52c powered by an AC motor plugged into a standard power outlet, for example, a 110V AC household power outlet. The worm screw may also be driven mechanically via a ratchet or the like 52d.

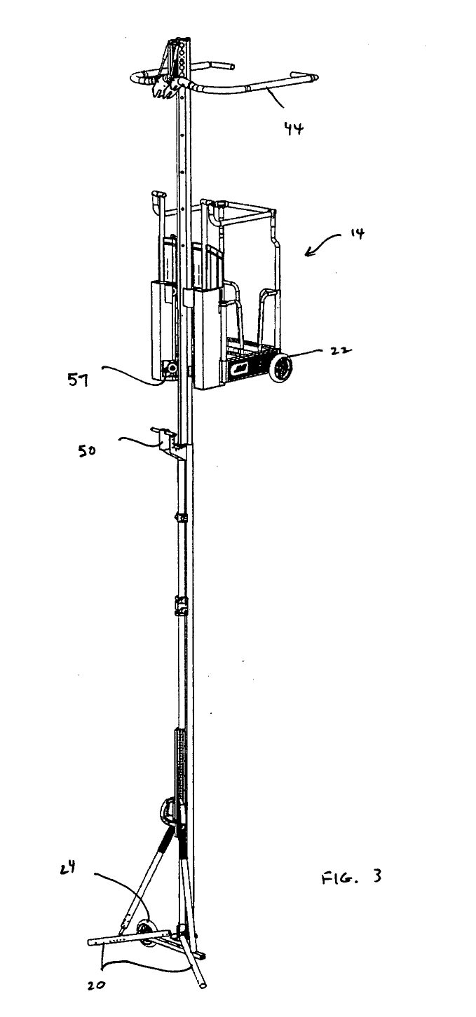

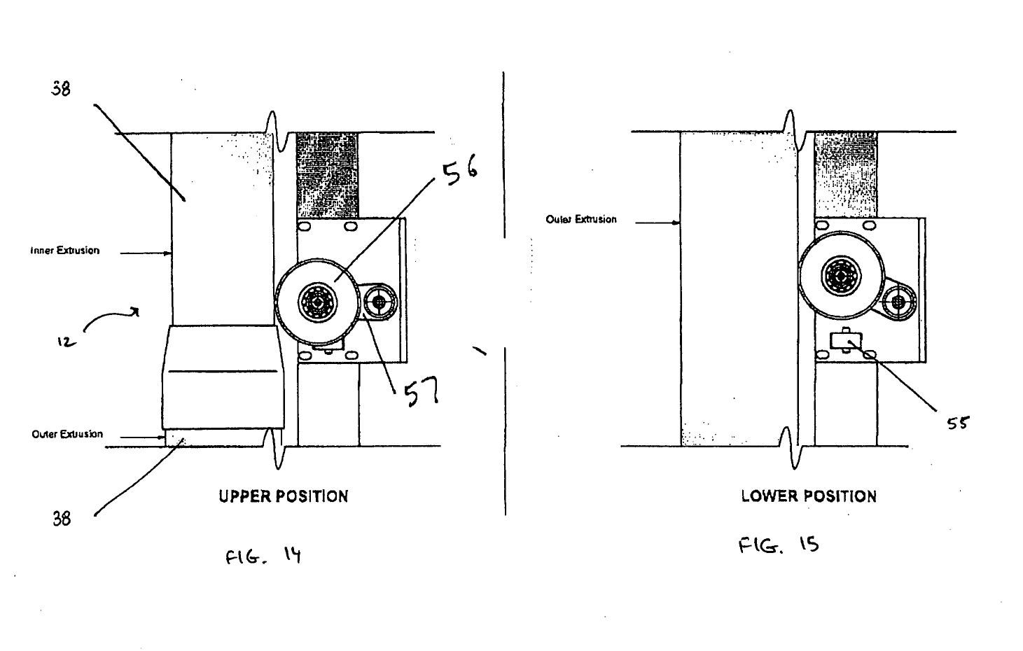

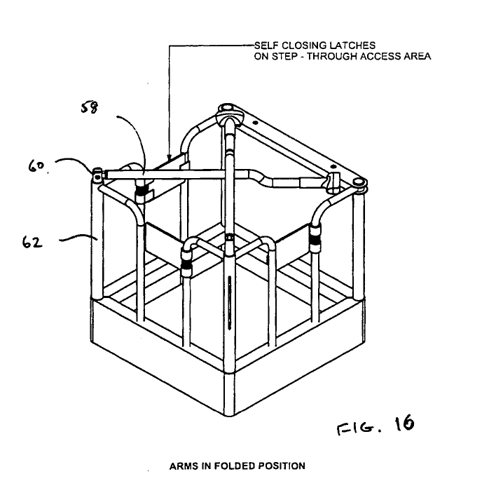

The work platform 14 is detachably mounted to a lifting bracket 54, which in turn is securely engaged with the mast 12 via a roller assembly 56. In this embodiment, with the telescoping sections of the mast 12, the roller assembly 56 is arranged to provide for minimum sway of the platform 14 when the rollers are on the smaller (inside) telescoping section. Preferably, with reference to FIGS. 3, 14, and 15, at least some of the rollers may be mounted on a pivot arm 57 which is urged to swing over-center by a spring or the like when the rollers pass onto the narrower telescoping section. An adjustable stop member 55 maintains a position of the rollers when engaging the smaller perimeter telescoping section 38.

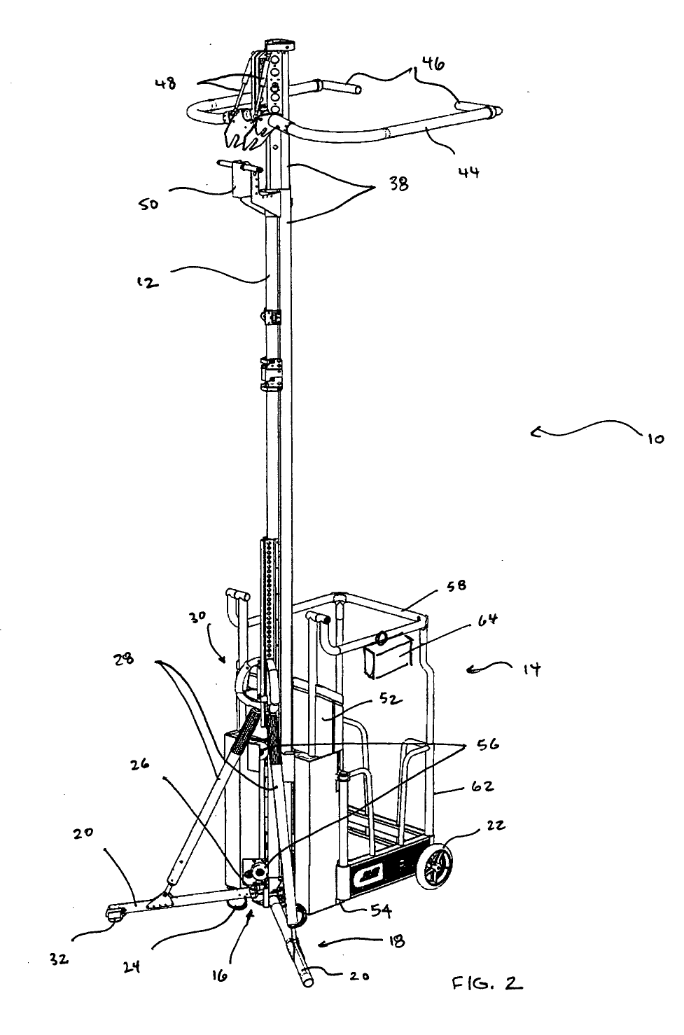

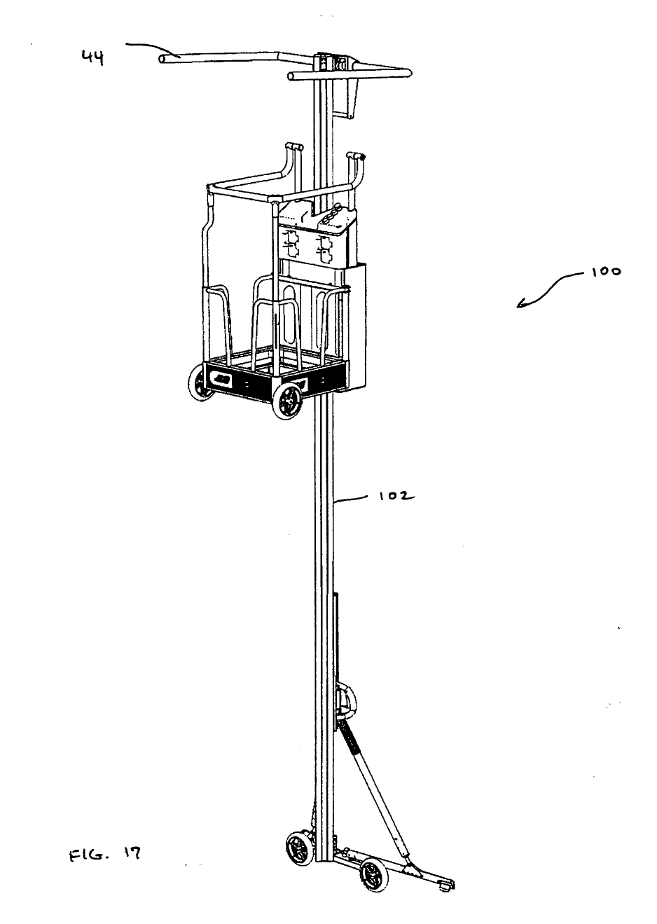

The work platform 14 preferably includes a safety rail 58 about its perimeter. The safety rail 58 may be pivotable to facilitate entry into the platform by the user. In use, the safety rail 58 at least partially or completely surrounds the user. For transport, the rails may be foldable in any suitable manner. Preferably, with reference to FIG. 16, the rails 58 are provided with a pivot joint 60 that is slidable in and out of a lower rail 62. When the pivot joint 60 is out of the lower rail 62, the safety rail 58 is readily pivotable to its folded position. In the open position, as shown in FIGS. 1-5, the safety rails 58 are aligned with the lower rails 62, and the pivot joint retracts into the lower rail 62 to lock the safety rail 58 in the open position. Additionally, the platform 14 is preferably provided with at least one tool container or tool caddy 64 (FIG. 2). The tool container 64 is preferably made of a flexible material and is attached to the platform via a breakaway pivot joint, which will break away upon impact to prevent damage to the operator or the platform 14 in the event a load over a predetermined low amount is exceeded.

The mast lift 10 according to this embodiment preferably has a maximum reach between 23-27 feet with a load capacity around 300-500 lbs. Moreover, a machine weight of the mast lift is preferably less than 200 lbs. As such, the mast lift 10 is transportable and operable by a single user. It is contemplated that variations of this embodiment could weigh as little as 150 lbs. or even 120 lbs.

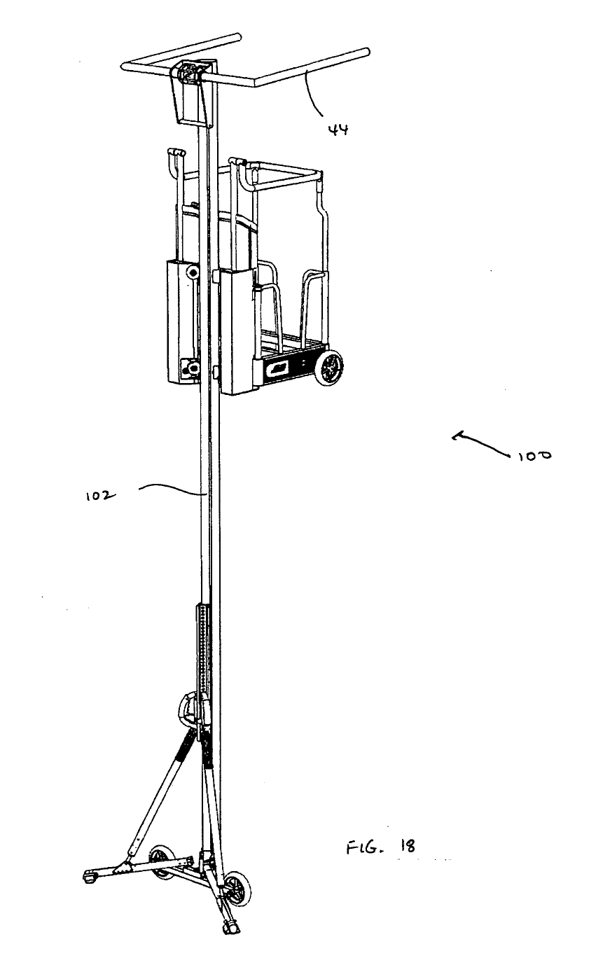

An alternative mast lift 100 is illustrated in FIGS. 17 and 18. The mast lift 100 of this embodiment is generally similar in construction to the mast lift 10 of the first embodiment, although the mast 102 is a single integral member and is not formed of telescoping sections. In this embodiment, the mast arm 44 is manually pivoted to its use position via a pulley system or the like. Other features of this embodiment are generally similar to the mast lift 10 of the first embodiment, and a description thereof will not be repeated. One variation allows for multiple sections of the mast to be stacked on top of each other for greater or reduced mast lengths (in transport position). Mast sections are bolted or pinned on as the platform is raised (similar to a self erecting crane used in heavy construction).

The non-telescoping mast lift 100 of this embodiment preferably has a maximum reach of 20-25 feet with a maximum capacity around 300-500 lbs. Like the first embodiment, a machine weight of the mast lift 100 is preferably less than 200 lbs. and, more preferably, as little as 80 lbs.

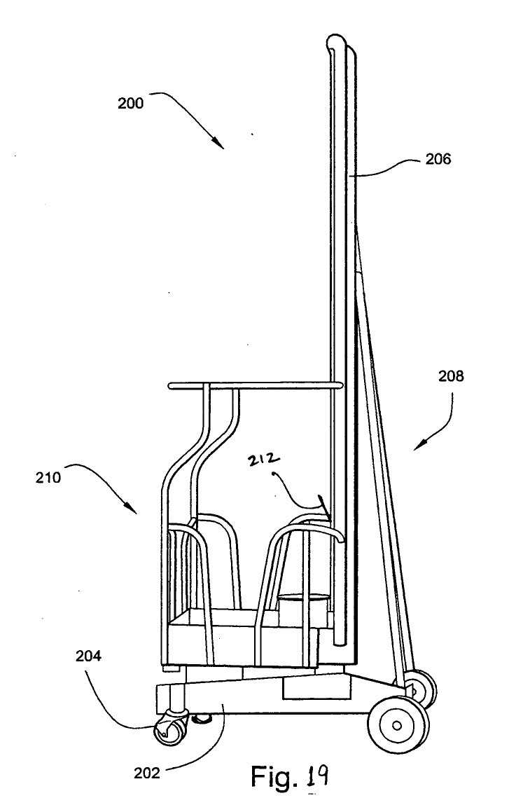

Yet another embodiment of the invention is illustrated in FIG. 19. The mast lift 200 of this embodiment includes a stand 202 having wheels 204, at least two of which may be caster wheels. The stand 202 supports a mast 206, which supports a lift mechanism 208 that raises and lowers a work platform 210 on the mast 206. As noted previously, the lift mechanism 208 may be any suitable mechanism to effect controlled raising and lowering of the platform 210 on the mast 206. The platform 210 may be fitted with a material tray to allow small packages to be lifted and retrieved.

In a preferred arrangement, the lift mechanism 208 includes a known Weston-type brake coupled with a gear train to reel in and out a cable or belt. A hoist gear of the Weston-type brake is preferably rotated via a power source such as a power pack (battery or AC power) or preferably a cordless drill. In the preferred embodiment, a cordless drill is coupleable with a power source coupling 212 to drive the gear train and thereby raise and lower the platform depending on a direction of rotation of the drill.

A maximum reach of the mast lift 200 of this embodiment is preferably between 13-16 feet with a maximum capacity around 300-500 lbs. A machine weight of the mast lift 200 is similarly less than 200 lbs. and preferably less than 150 or 120 lbs.

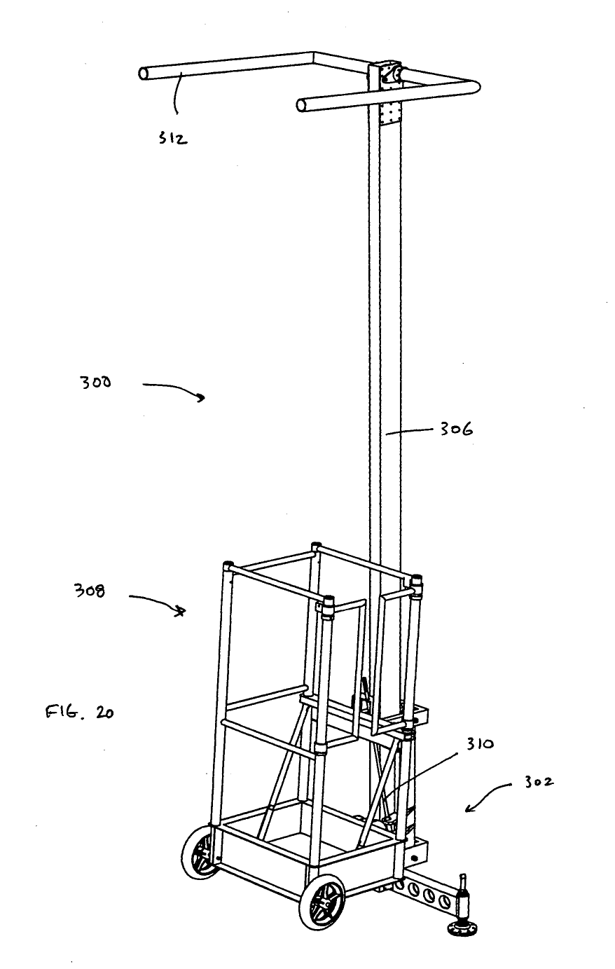

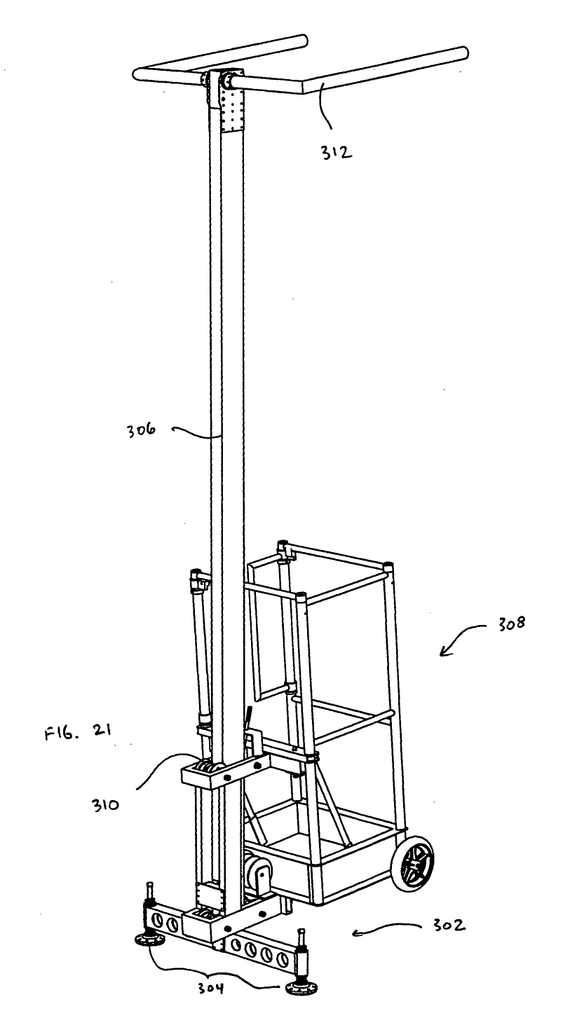

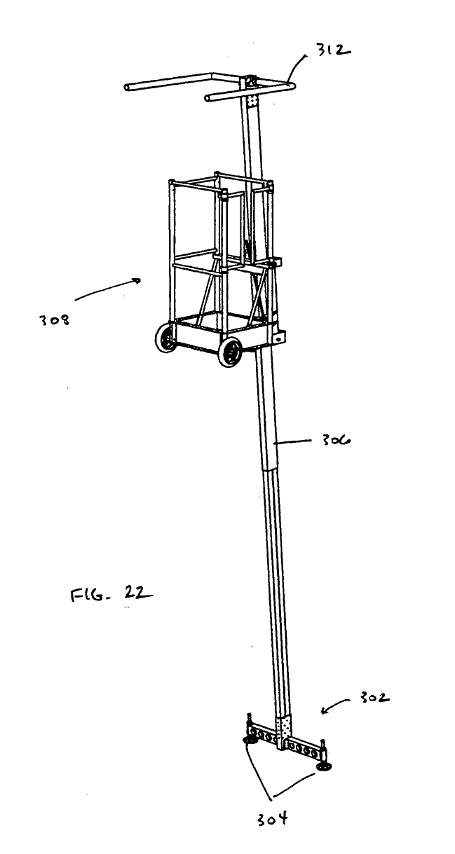

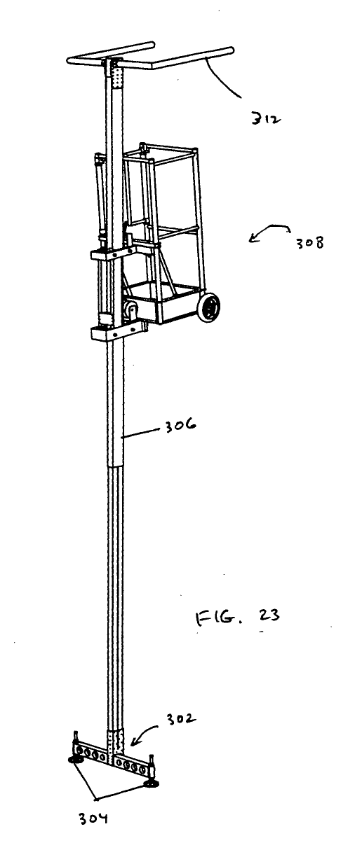

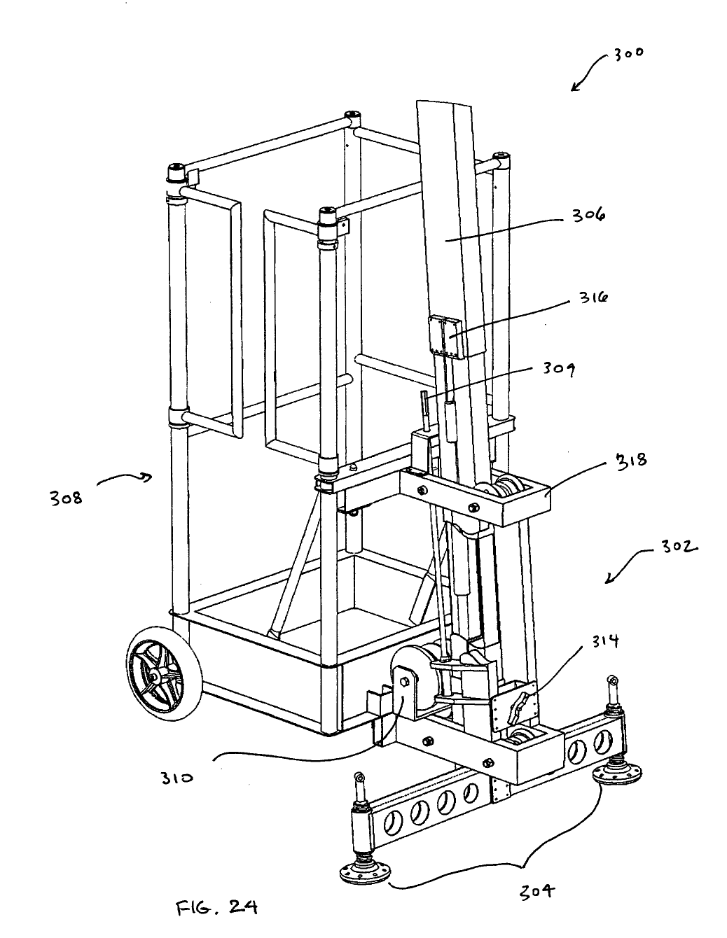

Still another embodiment of the invention is illustrated in FIGS. 20-24. This version of the invention is generally for light duty having a maximum load capacity of about 400 lbs and a maximum reach between 17-27 feet. The mast lift 300 includes a stand 302 having one or more leveling feet 304. The stand 302 supports a telescoping mast 306. A work platform 308 is raised and lowered on the mast via actuation of a lifting mechanism 310 through a power source coupling 309 (see also, FIG. 13). The lifting mechanism 310 is connected between the telescoping mast 306 and the work platform 308. A gas strut 311 (FIG. 24) is preferably disposed within the mast 306 and urges the mast toward the raised position. In use, with the work platform 308 locked in a home position with a carriage lock pin 314 or the like, operation of the lift mechanism 310 serves to raise and lower the mast 306. When the mast is raised and locked in position via telescope mast lock 316, the work platform 308 can be released by means of releasing the carriage lock pin 314, and in this configuration, driving of the lifting mechanism 310 causes the work platform 308 to be raised and lowered on the mast 306. The mast 306 includes a mast arm 312 for supporting the mast lift 300 against a support structure such as a wall or the like.

Two leveling feet 304 are shown in this embodiment each including a threaded connection to effect leveling of the mast lift 300, thereby enabling the mast lift to be used on uneven ground. As in the first and second embodiments, the mast lift 300 of this embodiment preferably requires two support points, wherein the stand 302 defines one of the support points, and the mast arm 312 defines the other of the support points. The two support point structure provides for stable operation of the mast lift 300.

In this embodiment, the functional performance has been optimized against the weight. The result is an integrated design that performs the basic lifting task. These functional elements, in a preferred arrangement, include: the single telescopic mast 306 with wall-ground contact points similar to a deployed ladder geometry; balanced cantilever legs of the stand 302 with the mast-leg junction close to the ground; the leveling system located on the foot (feet) 304; the arm(s) 312 manually deployed; a simple carriage structure 318 with lift mechanism 310 with the carriage wrapped around the mast 306 and the carriage incorporating diagonal struts between the top and bottom normally loaded rollers; the platform load carried at the bottom of the carriage/platform interface, and a winch drum of the lifting mechanism 310 mounted on the carriage 318 in the high strength area at the bottom of the carriage; and winch and worm gear yolks of the lifting system integrated into the carriage structure.

Also, in this embodiment, the thicker portion of the telescoping mast is at the top to provide less carriage wobble in the raised position without the need for other devices such as the swing-over rollers 57 described above. A simple mechanical carriage lock 314 is provided and preferably required during transport to prevent the carriage from rolling about and also to effect retraction of the mast. The arrangement of the carriage lock 314 and the telescoping mast lock 316 allows a single lift mechanism 310 to be used for both adjusting the telescoping mast 306 length and lifting the work platform 308.

The mast lift of the invention provides variations on single-user lifting platforms including a work platform raised and lowered on a mast. The lift is advantageously transportable and operable by a single user. The lift provides for greater stability and a larger working area than conventional ladders with reasonable manufacturing costs.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1-24. (canceled)

25. A work platform assembly comprising:
a supporting structure;
a work platform mounted on the supporting structure; and
a power source coupled with at least one of the supporting structure and the work platform, the power source providing motive power to the work platform assembly, wherein the power source comprises a hand-held power tool.

26. A work platform assembly according to claim 25, wherein the hand-held power tool comprises a power drill.

27. A work platform assembly according to claim 26, wherein the power drill is rechargeable.

28. A work platform assembly according to claim 26, wherein the power drill is cordless.

29. A work platform assembly according to claim 25, further comprising a lift system coupled between the work platform and the supporting structure, the lift system being powered by the power source to effect raising and lowering of the work platform relative to the supporting structure.

30. A work platform assembly according to claim 29, wherein the lift system is coupled between the work platform and the supporting structure by a gear train driveable via the power source through a power source coupling.

31. A movable work platform assembly comprising:
a supporting structure having wheels;
a work platform mounted on the supporting structure; and
portable means for providing motive power to the work platform assembly, the portable means comprising a hand-held power tool.

32. A movable work platform assembly according to claim 31, wherein the hand-held power tool comprises a power drill.

33. A movable work platform assembly according to claim 32, wherein the power drill is rechargeable.

34. A movable work platform assembly according to claim 32, wherein the power drill is cordless.

35. A movable work platform assembly according to claim 31, further comprising a lift system coupled between the work platform and the supporting structure, the lift system being powered by the portable means to effect raising and lowering of the work platform relative to the supporting structure.

36. A movable work platform assembly according to claim 35, wherein the lift system is coupled between the work platform and the supporting structure by a gear train driveable via the portable means through a power source coupling.

37. A method of positioning a work platform assembly, the work platform assembly including supporting structure, a work platform mounted on the supporting structure, and a power source coupled with at least one of the supporting structure and the work platform, wherein the power source is a hand-held power tool, the method comprising coupling the hand-held power tool to a power source coupling, and driving the hand-held power tool to provide motive power to the work platform assembly.

38. A method according to claim 37, wherein the hand-held power tool is a power drill, and wherein the power drill provides motive power to the work platform through a gear train.

39. A method according to claim 37, wherein the work platform further includes a lift system coupled between the work platform and the supporting structure, and wherein the driving step to provide motive power comprises driving the hand-held power tool to effect raising and lowering of the work platform relative to the supporting structure.
